(19) United States
(12) Patent Application Publication
(10) Pub. No.: US 2008/0071756 A1
(43) Pub. Date: Mar. 20, 2008

(54) Control, sorting and posting of digital media content

(76) Inventor: Arik Czerniak, Herzlia (IL)

Correspondence Address: Eitan Law Group;c/o Landon IP Inc., Suite 450, 1700 Diagonal Road, Alexandria, VA, 22314, US

(21) Appl. No.: 11/513,009

(22) Filed: Aug. 31, 2006

(51) Int. Cl. G06F 17/30

(52) U.S. Cl. 707/4

(57) ABSTRACT

A method and system for selecting content items for on-line posting is provided. The method may include receiving from voter(s) respective voting values for a stored content item and posting the content item if the voting values comply with a predefined distribution policy. The method may further include mitigating a weight of a voting value associated with a deviant voter and posting the content item if the weighted value is greater than a threshold value. Reviewers submitting voting values, which may be part of a control group, may be pre-selected clients and/or clients volunteering to serve as reviewers A voting value may be an aggregation of voter's rank(s) in one or more categories. The weight assigned to a rank or voting value may be dynamically changed in accordance with a voter's successive rankings in a given category or voting values.

### FIELD OF THE DISCLOSURE

The present disclosure relates to the field of digital media content distribution or posting over a data network such as the Internet and the like. More specifically, the present disclosure relates to the control, sorting and posting of digital media content to users of a data network such as the Internet.

### BACKGROUND

Data networking and transferring data over data networks continue to develop hand-in-hand. That is, the more sophisticated data networking gets the faster digital files can be transferred between any two locations connected to a common data network. Technological improvements in digital media and in the ways digital media can be accessed over the Internet result in more and more digital content being submitted and consumed by millions of individual users and content/service providers through out the world. In particular, Technological improvements continue to facilitate the creation of a wide variety of digital content and services in audio, visual, and audiovisual contents (hereinafter referred to collectively as “audiovisual content”) that are sent to customers through various media devices. Often, the ability to provide large amount of digital content and, at the same time to maintain high quality of service (“QoS”), is limited by the need to monitor, assess, evaluate or manipulate, huge amount of digital content in relatively very short time. The ability to provide large amount of digital content is also limited by the inability to meet all clients' requirements or desires as to the digital content each one of them wishes to consume.

Sometimes, due to the immense amount of audiovisual data that is handled by content providers, assessment, evaluation or manipulation, of the huge amount of digital content is, in many cases, impossible, or at least very inefficient. Therefore, in many cases, audiovisual content get stored in the content provider's system despite of the fact that they are likely to be accessed (consumed) only by a relatively small number of clients or, if relatively a large number of clients do consume them, many of them may find it obnoxious, abusive or boring. Other scenarios may exist, in which an audiovisual content is relatively popular (consumed by many clients) at the beginning, but later on many clients may loose interest in it.

One way to control audiovisual content that is distributed (posted) over data networks is by legislation. However, using legislation may prove inefficient because there is no global legislation harmonization as far as Internet content is concerned. In addition, human rights organizations worldwide usually condemn such legislations attempts as abusing or limiting the freedom of speech. For this reason (and for other reasons which are not specified herein), users of the Internet (for example) freely publicize un-criticized content items that may prove to be unpopular.

Another way to control audiovisual content that is distributed over data networks such as the Internet may involve employing an automatic ranking mechanism for audiovisual content selection. Such a mechanism may work in such a way that digital content will be judged by the viewers themselves, or at least by a predetermined control group consisted of reviewers, as opposed to it being censured by a governmental or non-governmental authority. Viewers will tend to discard unpopular, abusive or boring digital content. Discarding digital content will free memory space in the related content provider's system. However, such an automatic mechanism for audiovisual content selection does not seem to exist.

### GLOSSARY

“Digital content” (“content”, for short) generally refers herein to audiovisual like content files, each audiovisual content file may be a digital media file that may include, for example, picture(s), video streams, audio/music content, audiovisual content, text, and so on. Content may be stored and managed by one administrator, though it can be stored in different storage arrays or in a common storage array. Content may be forwarded by many users from their own personal computers (PCs) to the storage array(s), over a data network, in order for the content to be publisized to other users through the data network. “Content Item” generally refers to a single content file, for example a single video clip, piece of music, group of Powerpoint's pictures, and so on.

“Client” generally refers herein to a person forwarding digital content to (for the consumption of other clients) and/or consuming digital content from a content provider (or from other content sources) through a data network. Depending on the context, client may also refer to the computer used by a user to forward digital content to and/or consuming digital content from a content provider through a data network.

“Reviewers” generally refers herein to a group of clients functioning as a test, censure critic group (generally called herein a “control group”). Some clients may be asked to become reviewer(s) on a voluntary basis, and some other clients may be picked up automatically without them knowing of their selection as reviewers. A reviewer is intended to judge (vote for) a new content item (such as by ranking the content item in one or more categories) that has not been yet publicized, before a decision is reached whether the new content item is eligible and, therefore, can be consumed by clients that are not necessarily reviewers. A reviewer is a potential voter and s/he is a voter if s/he submits his/her a voting value for a content item. The group of reviewers may be as large as required or desired. Depending on a system manager's decision or on the process requirements, new items may be sent only to a preselected subgroup of reviewers or to the entire reviewers group. User(s) can be reviewer(s) and, at the same time, maintain regular users characteristics; that is, in addition to getting content item(s) for their own use (for entertainment or education purposes, for example), user(s) may get new content items which they will be asked to rank. Any new content item needed to be ranked will be sent to reviewer(s) with an appropriate message (for example “ranking needed”) that will prompt the reviewer(s) to rank the new content item.

“Voting value” is a value generated from rankings submitted by a reviewer for reflecting his/her impression of a new content item in one or more aspects or categories. For example, assuming that a given content item is to be reviewed in respect of the exemplary categories “voilence”, “pornography”, “amusing”, “interesting”, “thrilling”, a voting value associated with the given content item may be generated by ranking (by the reviewer) the content item in one or more of the categories, and aggregating rankings to obtain a voting value. A “Voter” is a reviewer submitting a voting value for a given content item.

“Min. ranks for distribution” (or “Min. ranks”, for short) is a ranking threshold value that reflects herein a wanted, or preferred, minimal number of reviewers that reviewed the content item involved (by ranking it in one or more categories). The Min. ranks threshold value is predetermined in order to ensure that a content item gets reviewed by a sufficiently large number of reviewers, which minimal number of reviewers may render the content items sorting process realistic. Of course, the greater the number of the reviewers ranking a content item, the more realistic the result of the sorting process will become.

“Min. avg. rank for distribution” (or “Min. avg. rank”, for short) is a threshold value that generally refers herein to a minimum average rank (in points, for example 4.4 points) needed to decide whether a given content item is an eligible item (that is, the content item's quality is sufficiently high), which renders the content item suitable for distribution. For example, in a scale of 1-5 points, 3 points may be predetermined as the Min avg. rank and any content item that has been ranked (on the average) 3 or more points may be considered an eligible content item.

“Max. Number of exceptional votings” (or “Max. exceptions”, for short) is a threshold value that generally refers herein to the maximum allowable number of exceptional, extreme, illogical, uncommon, unexpected or unrational rankings (herein referred to collectively as “deviant vote”) submitted by a given reviewer (herein referred to as a “deviant voter”), for which a voted content item will still be considered a content item that is eligible for distribution or posting.

The terms “distribution” and “posting” (which are interchangeably used herein) generally refer to sending to clients (on clients' demand) content items from content providers (or from an intermediator site associated with, or which provides sorting service to the content providers).

By “Mitigating a weight of a voting value associated with a deviant voter” (and also “mitigating a weight of a deviant voter”) is meant herein lowering the weight assigned to a voting value submitted by a deviant voter, usually because it conspicuously departs from the mainstream voting.

“Distrubution policy” is an aggregation of distribution rules. A distribution rule may be defined by, or associated with or derived from, a threshold value such as “Min. ranks”, “Min. avg. rank” or “Max. exceptions”, or other threshold value. A distribution rule may be defined by any other criteria and/or any combination consisting of any of the specified threshold values and other criterion and/or threshold value(s).

### SUMMARY

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other advantages or improvements.

As part of the present disclosure a method of selecting content items for on-line posting is provided. The method may include receiving from one or more voters respective voting values for a stored content item and posting the content item if the voting values comply with a predefined distribution or posting policy. The method may further include mitigating a weight of voting value(s) associated with deviant voter(s) and posting the content item only if the accumulating voting value for the voted content item, which is obtained after mitigating the weight of the deviant vote(s) (or deviant voter(s)) complies with the content items posting policy. In an embodiment of the present disclosure the content item is posted only if the accumulating vote value for the voted content item, is greater than a predetermined threshold value.

Reviewers (which may be part of a control group) submitting voting values may be pre-selected clients and/or clients volunteering to serve as reviewers A voting value may be an aggregation of voter's rank(s) in one or more categories.

According to an embodiment of the present disclosure the weight assigned to a rank or voting value may be dynamically changed in accordance with the reviewer's successive rankings in a given category or voting values. As part of the present disclosure a system is also provided, which may include a media content sorter adapted to facilitate the method.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. It is intended that the embodiments and figures disclosed herein be considered illustrative, rather than restrictive. The disclosure, however, both as to organization and method of operation, together with objects, features, and advantages thereof, may best be understood by reference to the following detailed description when read with the accompanying figures, in which:

FIG. 1 schematically illustrates an exemplary general system for automating the control and sorting of content item(s) according to an embodiment of the present disclosure; and

FIG. 2 is an exemplary flowchart for automatically controlling and sorting content items in accordance with an embodiment of the present disclosure.

It will be appreciated that for simplicity and clarity of illustration, elements shown in the figures have not necessarily been drawn to scale. For example, the dimensions of some of the elements may be exaggerated relative to other elements for clarity. Also, at times singular or plural (or options between singular and plural) may be described, however, notations or descriptions of singular include, or is to be construed as, plural, and plural include, or is to be construed as singular where possible or appropriate.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that tlroughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices,

Embodiments of the present disclosure may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present disclosure are not described with reference to any particular programming language. It will be appreciated that a variety of programming languages may be used to implement the teachings of the disclosures as described herein.

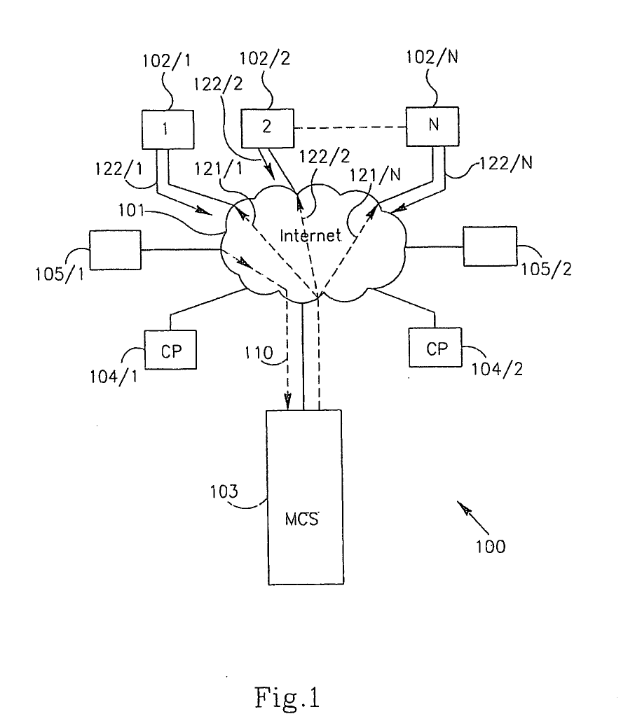

Referring now to FIG. 1, a system (generally shown at 100) for automating the control and sorting of digital media content is shown and described according to an embodiment of the present disclosure. Clients 102/1 to 102/N, Media Content Sorter (MCS) 103, Content Providers (CPs) 104/1 and 104/2 are shown connected to Internet 101. Clients 102/1 to 102/N are reviewers participating in a voting process. Reviewers 102/1 to 102/N, which form an exemplary control group, may be either pre-selected by MCS 103 for voting purposes, or they may volunteer to serve as reviewer(s), usually after being prompt to do so by MCS 103. For example, client 102/1 may be pre-selected by MCS 103 as a reviewer, and clients 102/2 through 102/N may serve as reviewers on a voluntary basis. A client pre-selected by MCS 103 as a reviewer may not be aware of his selection (by MCS 103) as a reviewer. Clients 105/1 to 105/2 are ordinary clients (they do not serve as reviewers), which means that they have not been selected by MCS 103 as reviewer(s) (for voting purposes), nor they volunteered to serve as reviewer(s).

Regardless of whether a client is a reviewer or regular viewer, each client may forward a content item to MCS 103 with the intention that other clients access that content item. For example, dotted line 110 denotes forwarding a content item from client 105/1 (an ordinary client in this example). Upon receiving a content item from any client, MCS 103 has to reach a decision (a distribution/discard decision) whether the content item forwarded to MCS 103 is an eligible content item (and therefore suitable for distribution to clients of Internet 101) or not, in which case the content item will not be distributed to any client which is not a reviewer. In order to facilitate the making of that decision, MCS 103 may forward, or distribute, the content item to the pre-selected and/or volunteering reviewers 102/1 through 102/N (shown at 121/1 through 121/N, respectively).

Each one of reviewers 102/1 through 102/N may (or may not) independently make his/her own vote, by ranking the content item in one or more categories according to his/her impression of the involved content item, and, thereafter, forward (shown at 122/1 through 122/N) a voting value corresponding to his/her ranking. Although each one of reviewers 102/1 through 102/N is shown (at 122/1 through 122/N) forwarding a voting value, it may occasionally occur that the number of reviewers actually voting on (sending their impressions in respect of) a given content item is less than N. For example, among 10,000 potential (pre-selected and/or volunteers) reviewers (N=10,000) only 2,500 reviewers may actually participate in a voting process associated with a given content item Different methodologies may be employed to get a reviewer's impression. For example, a review form may be used. According to this example MCS 103 displays to a reviewer an item for review. The item for review may be displayed to the reviewer as a picture or video clip (for example). Immediately after displaying the item to the reviewer, MCS 103 may cause a review form to pop-up and be displayed to the reviewer. Then, the reviewer may fill-in (“check”) pre-specified (check) boxes within the displayed review form by ranking the item he just viewed in one or more of the categories specified in the review form. Closing a review form by a reviewer may cause his rankings, or votes, to be submitted to MCS 103, which may generate therefrom a voting value associated with the reviewer. Another way to get a reviewer's impression is by using a ranking scale. According to this example, an interactive ranking scale may be displayed on the reviewer's display screen.

After receiving voting values from reviewers for a given content item, MCS 103 may mitigate a weight of (deviant) voting values, or (deviant) voting values, associated with a deviant voter or deviant voters, and post the given content item if the accumulating voting value obtained for the given content item, after mitigating deviant votes, is above, or grater than, a predetermined threshold value. In other words, a content item may undergo a reassessment process to reduce the effect of deviant votes on the final posting decision.

It can be decided, for example, that the occurrence of one deviant vote, for example in the “violence” category (that is, only one reviewer said that a content item is too, or very, violent), may suffice to disqualify that item, in which case the (disqualified) content item will not be posted. However, a deviant vote (voting value), or deviant voter may be reassessed after assigning to it/him/her a lower weight (lower than the maximal weight 1.0, which is a default, or initial, weight assigned to voting values), and the content item may eventually be posted if the reassessed accumulated voting value associated with the voted content item is greater than a predetermined threshold value.

Although it is assumed that the control group (or a sub-group thereof) generally represents the public majority's preferences as to publicized content items, it may sometimes occur that some reviewers vote (submit their ranks in one or more categories associated with a content item voted for) in an uncommon, unexpected or illogical manner, which may have unwanted implication on the voted content item and, therefore, on other clients. For example, a video clip (an exemplary content item) may include a violent scene which may generally be thought of as having an acceptable level of violence, but some reviewers may think that even scene(s) that include(s) the slightest, or even an implied, violence should not be distributed (should not be publicized or rendered accessible) to clients at all. Deviant voters contribute undesired or unwanted contribution to the decision making process. A reviewer is recognized as a deviant voter, for example if one of his/her currently submitted rankings in a given category is by way far from what is commonly accepted as streamline ranking. In order to minimize the effect of deviant voting on the final voting result, and therefore on the ensuing distribution or non-distribution final decision, each one of the voters may be characterized, for example by MCS 103 of FIG. 1, to maintain a generally more balanced control group that will represent the public's preferences in a more realistic manner.

Characterization of reviewers may involve, among other things, performing, automatically, several actions, among which is generation, per or for substantially each reviewer, of a personal reviewer file, which may contain the reviewer's viewing patterns or preferences, which may be identified such as by utilizing his past and/or current voting value(s) compared to voting value(s) characterizing, what may be though of as, mainstream preferences. A personal reviewer file may be dynamically and automatically modified to minimize the relative effect a deviant reviewer may have in different aspects of the voting process and/or on the final voting result, and, thus, on the posting decision.

### EXAMPLE-1

In an exemplary scenario a loyal reviewer, who is averse to consuming any kind of pornographic content item, may get a new content item for review, which is a short video clip that includes a relatively mild or soft pornographic material generally known to be popular. Being averse to consuming any kind of pornographic content item, the reviewer will likely categorize the content item as hard pornographic material with the intention that the content item will not be eventually publicized or rendered accessible to clients. However, according to the present disclosure since this (deviant) reviewer, and maybe a few more like (deviant) reviewers, is/are a negligible minority (that is, most of the reviewers ranked the pornographic video clip as soft porno), the reviewer may be marked by a media content sorter such as MCS 103 as a deviant voter whose voting (his voting value) makes an exception in that particularly category (in this example in the “pornographic” category) According to one embodiment of the present disclosure after being marked by the media content sorter as a deviant voter, the media content sorter may ignore future voting value(s) in that category, which will originate from the deviant voter. According to another embodiment of the present disclosure deviant ranking(s) (in one or more categories) of a deviant reviewer may be factored in after assigning to the deviant ranking(s) a lower weight. Further, if a deviant reviewer continues to submit a deviant ranking in respect of a given category, the deviant ranking may be assigned a lower weight. For example, if a weight assigned to a deviant ranking in the “violence” category is, say 0.95, and the same deviant reviewer submits (for a different content item) another deviant ranking in the same category (“violence”), his deviant ranking will be assigned a lower weight, say 0.75, and so on. In contradistinction, if the next ranking of a currently considered deviant reviewer is relatively close to what is considered to be a mainstream judgment (in the involved category), his ranking, in the involved category, will be assigned a higher weight. Weights assigned to rankings of a reviewer may, therefore, be changed dynamically, as the reviewer submits more and more rankings.

### Automatic Processing of Reviewers Inputs (Impressions Submissions)

After being reviewed by a sufficiently large number of reviewers, the media content sorter (MCS 103) may execute an evaluation process for evaluating voting values forwarded to it in order to determine whether the voted content item can be distributed/posted (rendered accessible) to clients or not. Assuming that a criteria predefined by the system administrator(s) have been met, an original or modified version of the content item may be distributed, or posted, to clients. For getting more realistic results, the evaluation process may be optimized by adjusting variables. The term “adjusting variables” generally refers herein, among other things, to adjustment(s) in the number of allowed exceptional voting occurrences. For example, when considering a pornographic item, it may be initially decided that the maximum number of ranks allowed as exceptional voting is 2. Considering the forgoing decision criterion, if more than 2 reviewers rank a given item as “pornographic”, the ranked content item will be disqualified for posting; that is, that content item will be regarded as being unsuitable for posting. However, if, for example, some or all of the items that got 2 porn-ranks are not pornographic, and most of the items that got 3 rankings are pornographic, the maximum number of ranks allowed as exceptional voting will have to be adjusted, in this example, from 2 to 3. Adjustment(s) in this, and also in other, variable(s) will render these variables more realistic and reflective.

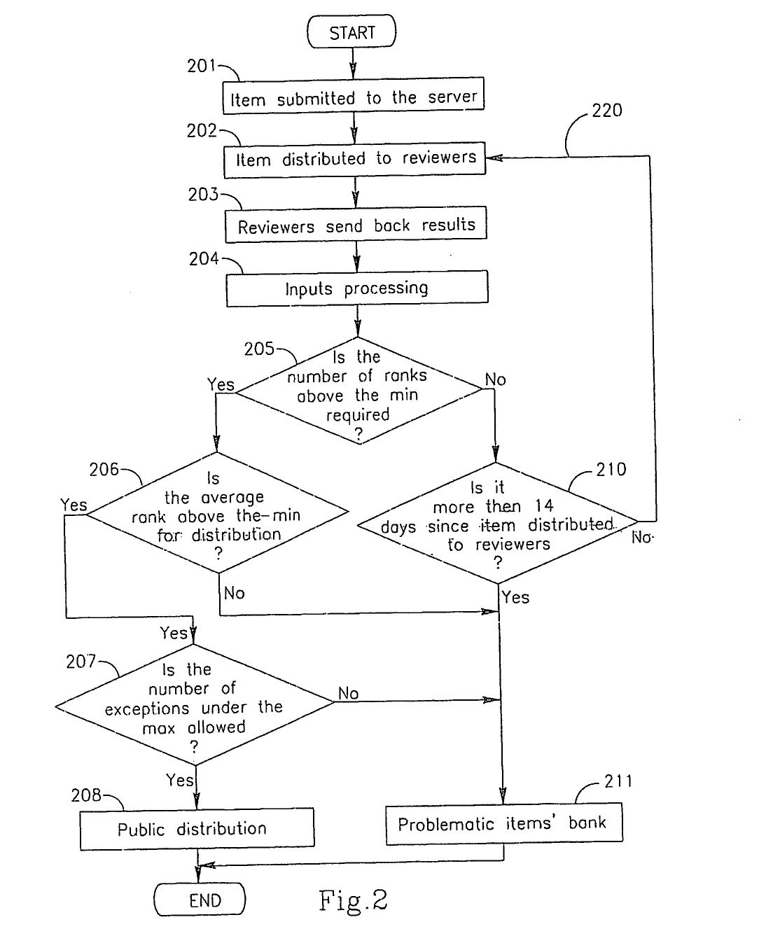

Referring now to FIG. 2, an exemplary flowchart for automatically controlling and sorting digital media content is shown and described according to an embodiment of the present disclosure. The exemplary flowchart of FIG. 2 will be described in association with FIG. 1. At step 201, a content item is forwarded from a client (for example from client 105/1) to a server such as MCS 103. At step 201 the forwarded content item is distributed to reviewers such as reviewers 102/1 through 102/N. At step 203, reviewers (for example 102/1 to 102/100, 100<N) forward their voting value(s), or ranking result(s). At step 204, the server (MCS 103) may process the received voting values (the voting results or ranks) and, at step 205, if the number of actual ranks submitted by reviewers is greater (shown as “Yes” at 205) than a Min. ranks threshold value, then it is checked, at step 206, whether the actual average rank is greater than the Min. avg. rank threshold value. If the actual average rank is greater than the Min. avg. rank threshold value (shown as “Yes” at 206) then, at step 207, it is checked whether the number of actual exceptions (deviating voting values) is less than the Max. exceptions threshold value. If (at step 207) the number of actual exceptions is less (shown as “Yes” at 207) than the Max. exceptions threshold value, then the media content sorter may publicize (distribute to clients) the voted content item (shown at step 208).

If the actual number of ranks is less (shown as “No” at 205) than the Min. ranks threshold value and more than a specified number of days (for example 14 days) elapsed (shown as “Yes” at 210) from the first day on which the content item was distributed to reviewers, then the media content sorter may discard the content item or temporarily store it in a problematic items bank (shown at 211), optionally for further statistical evaluations (for example). If, however, less (for example 3 days) than the specified number of days (for example 14 days) elapsed (shown as “No” at 210) from the first day on which the content item was first distributed to reviewers, then the media content sorter may redistribute (shown at 220) the content item to reviewers (shown at step 202), which may be the same reviewers or other reviewers. The other reviewers may be selected from the already existing control group (the control group originally defined by the media content sorter), and/or they may be clients newly added (by the media content sorter), as additional reviewers, to an existing control group, in which case it may be said that the control group is enlarged. Redistribution loop 220 may continue until the actual number of ranks is greater (shown as “Yes” at 205) than the Min. ranks threshold value, or more than a specified number of days (for example 14 days) elapsed (shown as “Yes” at 210) from the first day on which the content item was initially distributed to reviewers, whichever condition is met first.

If, however, the number of ranks is greater (shown as “Yes” at 205) than the Min. ranks threshold value, but the number of exceptions (deviating voting values) is greater than, or equal to, the Max. exceptions threshold value, then the media content sorter may discard the content item or temporarily store it in a problematic items' bank (shown at 211), for further statistical evaluations (for example); that is, if so desired.

FIG. 2 demonstrates ranking of a content item as a whole. However, it is to be understood that rankings may be submitted by reviewer(s) per predetermined category, and each category associated with the content item being voted may be judged on individual basis, including counting the number of rankings submitted, counting the number of exceptions (deviating rankings in the involved category) and calculating ranking average for the involved category Rankings submitted by reviewers, which may be associated with one or more categories, may be processed at step 204 of FIG. 2, and steps 205 and/or 206 and/or 207 and/or 210 may applied to each one of the one or more categories involved. According to an embodiment in order for a contetn item to be rendered accessible to clients, all ranked categories have to comply with the distribution criteria described herein.

### EXAMPLE-2

Company X, a content publisher or provider over the internet, has 10 million clients that submit between 10,000 and 20,000 new content items (of different kinds) each day. In its portal, company X publishes a banner that encourages clients to assign as reviewers. Each client serving as a reviewer will receive from company X new content items for review, which have not been been publicized yet A reviewer may continue to freely consume already publicized content items from company X and/or from other content providers. In accordance with this example, 10,000 clients positively responded and now they serve as reviewers.

It is assumed that company X has defined a distribution policy which includes the following four exemplary distribution rules:

### 1. New item(s) will be forwarded for review to at least 500 reviewers (Min. ranks=500).

### 2. In order for a content item to be publicized, the content item has to get an average rank of at least 3 points out of 5 (in this example Min. avg. rank=3).

### 3. If the content item gets 2 or more rejections (in this example Max. exceptions=2) in any of the categories “certain images”, “certain implications”, “violence” or “pornography”, the content item will be disqualified and not be publicized/posted.

4. If the content item does not get enough impressions from reviewers and 14 days (for example) elapsed from the day the content item was first forwarded to the reviewers, the item will not be publicized. “Not get enough impressions from reviewers” means that eventhough the content item was forwarded to a sufficiently large number of reviewers (the content item was forwarded to a number of reviewers larger than Min. ranks), many of them were not interested in ranking the content item, regardless of their reasons.

For the sake of the example it is assumed that client A submits a content item with the intention that the content item be publicized and consumed by other interested clients. It is also assumed that the content item is distributed only to 700 reviewers with a message, for example in the form of an icon, attached to, or associated with, the content item, which says that this content item is a new content item awaiting reviewing. It is also assumed that five days later 500 impressions (respectively originating from 500 clients) were recorded at the media content sorter, with the following results:

### 1. The calculated average rank was 3.2 (Avg. rank=3.2), which is greater than the predetermined threshold value (Min. avg. rank=3.0, see distribution rule 2).

2 One rejection has been recorded in the “violence” category, which, according to distribution rule 3, is one rejection less than the maximum allowed number (Max. exceptions=2), whereas the other 499 reviewers found this content item eligible in all of the exemplary categories specified by exemplary distribution rule 3 described earlier.

According to Example-2 the content item may be publicized and the reviewer who rejected the content item (for being violent in his opinion) will be marked by the media content sorter as a deviant reviewer, for which reason whenever that reviewer will refer (in his review(s) of future content item(s)) to the “voilence” aspect of item(s), his voilence-wise rankings will be assigned a lower weight, so as to reduce their effect on the final item content posting decision. Reviewers rankings may be initially assigned the maximal weight of 1.0, and a ranking (in any of the categories involved) of a deviant reviewer will be assigned a lower weight, for example 0.85. In general, the more deviant is a user relative to a mainstream ranking in a given category, the lower the weight assigned to his ranking would be in the given category.

### EXAMPLE-3

Example-3 is similar to Example-2 except that 5 days after the content item was first (initially) distributed to the reviewers, only 450 reviewers responded positively, by forwarding their impressions, or rankings (voting values) to the media content sorter. In such a case, two solutions are possible (as is implied by FIG. 2): (1) The content item will not be publicized, and (2) The content item will be resent to reviewers and/or it will be forwarded to other or additional reviewers in order to meet the “Min. ranks” criteria. This process can iterate several times, until the content item gets enough ranks or two weeks elapsed (for example). Whichever solution will be adopted depends on the definitions set by the content provider (in this example company X).

According to one embodiment of the present disclosure rankings of a deviant voter may be weighted per category. That is, only the weight of rankings in a category, for which at least one deviant ranking is/was submitted by a deviant voter, may be mitigated (such as by assigning to these rankings a lower weight). According to another embodiment of the present disclosure substantially all rankings in each voted category may be assigned a lower weight regardless of the category, or categories, for which at least one deviant ranking is/was submitted by a deviant voter.

According to an embodiment means may be provided for enhancing content items posting decisions, by minimizing posting probability of ineligible content items. According to this embodiment an “interactive ranking” (an “indirect ranking”) method may be employed, which may enable the updating of clients' rankings by automatically recording, analyzing and learning client(s) impression of content item(s) from different actions done (intentionally, accidentally, occasionally or unconsciously) by them without being asked to do so. Studied impressions may then be used to update, revise or refine ranks submitted in the way described hereinbefore (which may be called “direct ranking”, as opposed to the interactive ranking or indirect ranking). Updating, revising or refining ranks may significantly improve (relative to using direct or average rankings alone) the decision making process associated with the distribution or posting of eligible content items, because, in statistics, the more data is considered the more accurate the statistical analysis may get.

### Possible Responses from Clients

When a new content item is sent to a reviewer for voting, the reviewer may do one or more of several actions (herein referred to as “client actions”) in respect of the content item. Client actions may include the following exemplary indicators: (1) watching the same content item more than once by the same (a probable indication that the content item is, for example, fully and/or amazing and/or attractive, or it is interesting in any other way), (2) saving the content item after reviewing it (a probable indication that the content item is worth saving, for example, for being funny and/or amazing and/or attractive, or it is interesting in any other way), (3) deleting the content item before or after reviewing it (a probable indication that the content item is not worth watching or, if it is deleted after it is watched, a probable indication that the content item is, for example, boring or abusive), (4) mailing the content item to other client(s), whether they are reviewers or not (a probable indication that the content item is worth mailing, for example, for being funny and/or amazing and/or attractive, or it is interesting in any other way), and (5) stopping playing the content item before it ends (a probable indication that the content item is, for example, boring or abusive), receiving comments from many users (a probable indication that the content item is funny and/or amazing and/or attractive, or it is interesting in any other way), and so on.

Regarding the “stopping of a played content item” client action, the overall time-wise length of the content item is taken into account. That is, if reviewing of a relatively short content item (for example the item is a 10-second video clip) stops before it ends, a conclusion that the content item is boring or abusive will be reasonable. However, if reviewing of a relatively long content item (for example the item is a 7-minute video clip) stops before it ends, a conclusion that the client cannot afford watching the content item that long will be reasonable. Stopping an item review before it ends when the item is relatively short is, therefore, usually more significant (have higher weight) than doing so on a longer item.

Regarding indicator number 1 above (“watching a content item more them once”), although watching a content item two or more times may indicate that the content item being involved is a demanded item, an explicit (direct) ranking by the client (for example ranking the item 5 out of 5 in a ranking scale) may reflect the client's impression more realistically, in which case the indicator number 1 above will be less significant than the explicit and direct ranking.

The exemplary client actions described before, and other client actions that may also be used (which may depend on the nature and/or features of the content item), may be recorded, processed and used, such as by MCS 103 of FIG. 1, to obtain a much more realistic conclusion from clients' impressions of a given content item. Different client actions may have different relative weight or significance and, therefore, it may be beneficial to first characterize client actions and then to establish the relative weight or significance of the client actions involved. Indicator(s) used to characterize client actions may be adjusted and, if required or desired, readjusted according to circumstances, so that they will facilitate the enhancement of ranking of content items.

### EXAMPLE-4

Company ABC, a content provider or publisher over the internet, has 10 million clients that submit 10,000 new content items every day. The company gives reviewers, which may be clients and/or users, an option to rank each content item from 1 (the lowest rank) to 5 (the highest rank) by using an interactive ranking scale that may be located, for example, in the company's web portal. The “interactive ranking scale” is interactive in the sense that responsive to the reviewer selecting (for example by using a computer mouse) a voting value, say “2” in a ranking scale of 1 to 5, the selected (the “clicked”) voting value may be forwarded to an evaluation controller such as MCS 103. A rank scale may be the only thing that the clients see; that is, in addition to content item(s) which are introduced to them, and the clients may be asked to interact with the ranking scale in order to rank content item. It is noted that there is a difference between reviewing content items by reviewers, which are part of a control group, and reviewing of content items by clients (by the public), as is explained hereinafter.

Put differently, a content item may be distributed to control group's reviewers for ranking in order to determine whether the (reviewed) content item is eligible for distribution to the public (to clients). The ranking process associated with reviewers may be called “pre-distribution ranking”. If a decision is reached that the reviewed content item can be posted (it may be distributed to the public)—, clients may still be able to rank this content item, for example by using the ranking scale appearing, for example under the posted content item. In this regard, if, according to the pie-distribution ranking process, a content item is eligible for posting to the public, the content item may be posted or distributed to (or consumed by) the public with an initial rank value which may be derived from reviewers rankings. From now on, each client may independently decide, possibly based on the item's initial rank value and/or future (updated) value thereof, whether to actually use that content item. As long as the content item is distributed to clients (to the public), clients may rank it, for example by using an interactive ranking scale, and the initial item's rank may be updated, revised or refined, as additional like rankings are received from the public. The latter ranking process may be called “post-distribution ranking”.

In addition, company ABC utilizes the following exemplary interaction definitions or terms (interaction policy):

1. For every 5 reviewers who independently watched a content item more then once the reviewed content item will be assigned one 5-point rank. For example, if 15 clients watched a content item more then once, the reviewed content item will be assigned 15 points;
2. Each content item that is commented by more then 500 reviewers (for example) and its average rank is less then 4 will be automatically ranked as 4. The rationale behind this definition is that if a number of comments that is at least as high as 500 (for example) is compared against a low direct ranking (less than 4, for example), the number of comments prevails;
3. Every 10 indications of mailing of a content item to another client(s) will be equal to one 5-point rank. For example, if 30 indications were identified, which indicate that 30 clients e-mailed the involved (voted) content item to other client(s), then the content item will be assigned 15 points;
4. Every 5 times that a content item is saved by client(s), for example on their personal computers (PCs), will be equal to one 5-point rank. For example, if the involved (voted) content item was saved 30 times by client(s), the content item will be assigned 30 points; Every 10 times that a content item is deleted from the portal by client(s) will be equal to one 1-point rank; and

5. Every 5 times that a content item is stopped before the completion of the first review will be equal to one 1-points rank

It is assumed that content items X and Y were forwarded from company ABC to the company's web portal a week ago and, until now, the following interaction data has been received and/or derived, which is associated with content items X and Y:

Content item X was ranked by 500,000 reviewers as follows: 100,000 clients gave it 5 points, 300,000 clients gave it 4 points and 100,000 clients gave it 3 points. Accordingly, the average rank for content item X is 4 points (Avg. rank=4.0);

Content item Y was ranked by 500,000 reviewers, as follows: 250,000 clients gave it 5 points and 250,000 clients gave it 4 points. Accordingly, the average rank for content item Y is 4.5 points (Avg. rank=4.5);

Content item X was saved by 500,000 reviewers and e-mailed 100,000 times; and

### Content item Y was deleted by 5,000 reviewers and 100,000 reviewers stopped reviewing it before its full playing time elapsed.

It is also assumed that during the last week the interaction data designated 1 through 4 (which are specified hereinbefore) were processed by a media content sorter such as MCS 103 of FIG. 3 to update the rank of content items X and Y, and now, at the end of the week, the updated ranks (the interactive ranks) associated with content items X and Y are 4.11 and 4.36 points, respectively (instead of 4.50 and 4.00 points that were obtained by using the “direct ranking” process described hereinbefore).

As is clearly shown from Example-4, the ranking gap between content items X and Y is, in this example, narrower after the updating of the ranks (0.25, as opposed to 0.5 before the ranks update). The updated values of the ranks related to content items X and Y better represent the genuine impression of the clients of content items X and Y. The latter feature of refining the content items selection process, which is based on updated ranks obtained by exploiting clients' actions, is an important feature, especially in cases where a company (such as exemplary company ABC) has to to distribute best quality content items which are to be selected from a large number of content items.

Referring again to Example-4, content item X has, after updating its rank, a better chance to be distributed because content item X has got now (as a result of the use of interactive ranking) a higher rank; that is, 4.11 points, as opposed to the “base rank” or “initial rank” of 4.00 points which content item X got using basic ranking that utilizes the reviewers' ranks but not client(s)' actions. Regarding content item Y, content item Y has, after updating its rank, a lower chance to be distributed because content item Y has got now (as a result of the use of interactive ranking) a lower rank; that is, 4.36 points, as opposed to the “base rank” or “initial rank” of 4.50 points which content item Y got using basic ranking that utilizes only the reviewers' ranks but not client(s)' actions. The updated rank associated with content item Y has become lower (4.36 points as opposed to 4.50 points) because the interactive ranking process factors in the fact that 5,000 reviewers deleted content item Y item and, in addition, content item Y was not reviewed even once by 100,000 reviewers, in addition to the direct (explicit) ranks provided by the reviewers.

### EXAMPLE-5

Example-5 is similar to Example-4 except that company ABC decides that only content items ranked more than 3.5 points will be considered eligible for distribution. It is assumed that content item Z has been ranked 3.7 points and, therefore, a company (such as company ABC) adopting the direct or explicit ranking methodology would reach a decision to distribute content item Z, for it was ranked 3.7 point which is more than the minimum rank required (3.5 points). However, given the assumption that content item Z was forwarded to additional 500,000 reviewers who did not rank it (regardless of the reason), and assuming, in addition, that most of the additional 500,000 reviewers deleted content item Z and\or stopped reviewing content item Z in the middle of its review and that company ABC adopts the interactive or implicit ranking methodology, the explicit rank (3.7) may be updated by using the additional indications. According to Example-5, the updated rank of content item Z is 3.4, which means that content item Z has become less eligible and, therefore, a decision to stop its distribution may be reached by company ABC.

Assuming that a new content item is forwarded to a given control group and reviewers of the control group submit their ranks to two different systems—a first system that employs the direct ranking methodology and a second system that employs the interactive ranking methodology—the second system will reach a more realistic decision faster than the first system, because, while the second system exploits indication(s) that are derived from client(s)' actions, the first system may have to forward the content item, for review, to additional reviewers, which may significantly extend the time required for the first system for reaching a decision whose quality or realistic nature matches, or is similar to, the decision reached by the second system.

While certain features of the disclosure have been illustrated and described herein, many modifications, substitutions, changes, and equivalents will now occur to those skilled in the art. It is, therefore, to be understood that the appended claims are intended to cover all such modifications and changes as fall within the true spirit of the disclosure.

What is claimed is:

1. A method of selecting content items for on-line posting, comprising:
receiving from one or more voters voting values for a stored content item and posting the content item if the one or more voting values comply with a predefined posting policy.

2. The method according to claim 1, wherein a weight of voting values associated with one or more deviant voters is mitigated and the content item is posted if the accumulating voting value obtained after mitigating the weight values, is greater than a threshold value.

3. The method according to claim 1, wherein a voter is part of a control group consisting of reviewers.

4. The method according to claim 3, wherein reviewers are pre-selected clients.

5. The method according to claim 3, wherein reviewers are clients volunteering to serve as reviewers.

6. The method according to claim 1, wherein a voting value comprises voter's rank(s) in one or more categories.

7. The method according to claim 2, wherein the weight dynamically changes in accordance with a voter's successive rankings in one or more categories.

8. The method according to claim 2, wherein a ranking in a given category is assigned a lower weight if said ranking follows successive deviant ranks in the given category.

9. The method according to claim 2, wherein the distribution policy comprises, per involved category, receiving a number of ranks greater than a minimum threshold value and the average ranking value being greater than a minimum average threshold value, and the number of exceptions being less than a maximum threshold value.

10. The method according to claim 6, wherein the content item is posted if ranks related to all categories comply with the posting policy.

11. A system for selecting content items for on-line posting, comprising:
a media content sorter adapted to receive from one or more voters respective voting values for a stored content item and to post said content item if said voting values comply with a predefined distribution policy.

12. The system according to claim 11, wherein the media content sorter is further adapted to mitigated a weight of voting values associated with one or mores deviant voters and to post a content item if the accumulating voting value obtained after mitigating the weight values is greater than a threshold value.

13. The system according to claim 11, wherein voters are reviewers pre-selected clients.

14. The system according to claim 13, wherein reviewers are clients volunteering to serve as reviewers.

15. The system according to claim 11, wherein the media content sorter is further adapted to receive voter's ranks in one or more categories.

16. The system according to claim 11, wherein the media content sorter is further adapted to dynamically change the weight in accordance with a voter's successive rankings in a given category.

17. The system according to claim 15, wherein the content item is posted if ranks related to all categories involved comply with the distribution policy.
